(19) United States
(12) Patent Application Publication
(10) Pub. No.: US 2026/0227142 A1
(43) Pub. Date: Aug. 6, 2026

(54) 3D Printed Bolt Receiver with side anchor surfaces

(71) Applicant: Bobby McCreight, Bulverde, TX (US)

(72) Inventor: Bobby McCreight, Bulverde, TX (US)

(21) Appl. No.: 19/448,677

(22) Filed: Jan. 14, 2026

Related U.S. Application Data
(60) Provisional application No. 63/746,494, filed on Jan. 17, 2025.
(60) Provisional application No. 63/751,937, filed on Jan. 31, 2025.

(51) Int. Cl. F41A 3/66; B33Y 80/00; F41G 11/00

(52) U.S. Cl. CPC F41A 3/66; B33Y 80/00; F41G 11/003; F41G 11/004

(57) ABSTRACT

A firearm sighting system and method are disclosed. A firearm receiver includes an upper mounting interface and a lateral mounting interface on a side region of the receiver. A first optical sight is mounted to the upper mounting interface and defines a first optical axis. A second optical sight is mounted to the lateral mounting interface, directly or via a mounting bracket, and defines a second optical axis laterally offset from the first optical axis. The lateral offset positions the second optical sight for binocular use such that, when the firearm is shouldered, a shooter can view through the second optical sight with one eye while simultaneously viewing through the first optical sight with the other eye. The lateral mounting interface may be located on either side of the receiver. In some embodiments, an AR-style upper receiver includes a laterally projecting horizontal mounting surface defining the lateral mounting interface.

### RELATED APPLICATIONS

This application claims the benefit under 35 USC 119(e) of U.S. Provisional Application Nos. 63/746,494, filed on Jan. 17, 2025 and 63/751,937, filed on Jan. 31, 2025, both of which are incorporated herein by reference in their entirety.

### BACKGROUND OF THE INVENTION

Bolt Action (BA) is a type of firearm mechanism commonly used in rifles that involves manually operating a bolt to load a cartridge into the chamber as well as to extract and eject the cartridge after the firing. Bolt action rifles are widely used and known for their reliability, accuracy and simplicity, and have been broadly used in hunting, precision shooting and military. Key parts of the bolt action include the bolt assembly which consists of bolt body, bolt handle, firing pin, extractor and ejector, and locking lugs.

A bolt receiver is a component that functions as a shroud or housing that encloses the bolt assembly and that serves multiple purposes: as pressure vessel protection and aesthetic enhancement as well as functional and practical design geometry. It acts as the primary housing for the bolt assembly allowing it to cycle and provides structural framework for other critical components of the firearm such as a primary optic surface located at the top-center of the receiver as has been done since its inception. The receiver sits between the firearm's barrel and stock or chassis.

The stock, traditionally, is made from wood, but is currently often an aluminum, plastic or composite chassis, designed to support the barreled action. This also provides a comfortable and stable platform for aiming and firing. It has a variety of shapes and can be customizable for ergonomic and shooting needs.

Modern chassis are a traditional stock replacement that offer modularity, allowing adjustments in length of pull, comb height and attachment points for accessories such as rails, and other shooting aids. These chassis are often manufactured from aluminum, composites, or other durable materials and provide more customization options in precision shooting or tactical applications.

A recoil lug is a crucial component in rifles as well. The primary purpose of a recoil lug is recoil management and alignment. Particularly in the bolt-action receiver, it helps to manage the forces generated by the firing of a round by transferring those forces to the stock or chassis. It is often small, usually a flat metal piece located between the barrel and the action of the rifle and often is integral with the bolt receiver. The barrel passes through the recoil lug and the lug itself is sandwiched between receiver and the stock during assembly. Typically, a recoil lug is located at the front of the receiver, in the location where the barrel is threaded into the receiver.

The most commonly used material for receivers and bolt assemblies is steel such as carbon steel and stainless steel, which gives a high tensile strength to withstand firing pressure. Other possible materials include nickel alloys, aluminum, steel, titanium and carbon fiber. Aluminum alloy receivers are lightweight and corrosion-resistant and are often used in modern lightweight firearms, particularly semi-automatic rifles and carbines.

Many receivers have an integrated mounting rail located at the 12-oclock position allowing for the primary day optic, or screw holes to affix such a rail or optic.

### SUMMARY OF THE INVENTION

The present disclosure relates to firearm sighting arrangements in which a firearm receiver supports more than one optical sight in a manner that improves adaptability and enables rapid use of different sighting modalities. In various embodiments, the receiver provides an upper mounting interface on an upper region of the receiver for a primary optical sight and a lateral mounting interface on a side region of the receiver for a secondary optical sight, such that the sights move with the receiver under recoil and maintain a fixed relationship to the firearm.

In one aspect, a firearm sighting system includes a receiver having both the upper mounting interface and the lateral mounting interface. A first optical sight is mounted to the upper mounting interface and defines a first optical axis. A second optical sight is mounted to the lateral mounting interface and defines a second optical axis that is laterally offset relative to the first optical axis. The lateral offset allows the second optical sight to be positioned for access by a shooter's other eye, while the first optical sight remains in a conventional upper mounting location.

In some embodiments, the upper mounting interface comprises a rail or base located at an upper portion of the receiver, such as a Picatinny-type rail, for mounting a primary optic including a magnified telescopic sight. In some embodiments, the lateral mounting interface comprises a laterally facing or laterally projecting mounting surface and includes one or more fastener features such as threaded openings for receiving threaded fasteners, and may additionally include one or more indexing features (for example, one or more pin holes, dowel recesses, or locating bosses) to resist rotation and/or to improve repeatable positioning of an accessory.

In some embodiments, the second optical sight is coupled to the lateral mounting interface directly or via a mounting bracket. The mounting bracket may include a base portion secured to the receiver at the lateral mounting interface and an optic-support portion spaced from the base portion to position the second optical sight in a laterally offset viewing position relative to the first optical sight. In some embodiments, the first optical sight provides magnification and the second optical sight is a non-magnifying reflex sight, although other combinations of optical sights may be used.

In some embodiments, the first and second optical sights are arranged such that, when the firearm is in a normal shouldered firing position, a shooter can view through the second optical sight with one eye while simultaneously viewing through the first optical sight with the other eye. In certain examples, the bracket and/or the lateral mounting interface positions the second optical sight such that the first and second optical axes are generally parallel and/or aligned to a common point of aim at a selected distance.

In another aspect, an upper receiver for a firearm (including an AR-style upper receiver) includes a top rail forming the upper mounting interface and further includes a laterally offset mounting structure forming the lateral mounting interface, such as a laterally projecting horizontal mounting/anchor surface, configured to receive an accessory mount and to support a secondary optical sight laterally offset from a primary optical sight mounted on the top rail.

In various embodiments, the receiver and/or the mounting interfaces can be formed integrally with the receiver or can be provided as attached components, and can be manufactured using traditional machining and/or additive manufacturing techniques. When manufactured additively, the receiver and the mounting interfaces may be formed as a monolithic structure, including features that provide increased rigidity and improved packaging for mounting multiple optical sights in close proximity to the shooter.

In one embodiment, a firearm sighting system comprises: a firearm receiver; an upper mounting interface on an upper region of the receiver; a lateral mounting interface on a side region of the receiver; a first optical sight mounted to the upper mounting interface and defining a first optical axis; and a second optical sight mounted to the lateral mounting interface and defining a second optical axis; wherein the second optical axis is laterally offset from the first optical axis; and wherein the first optical sight and the second optical sight are arranged such that, when the firearm is shouldered, a shooter can view through the second optical sight with one eye while simultaneously viewing through the first optical sight with the other eye.

In one embodiment, a method for configuring a firearm comprises: providing a firearm comprising a receiver having an upper mounting interface and a lateral mounting interface; mounting a first optical sight to the upper mounting interface such that the first optical sight defines a first optical axis; mounting a second optical sight to the lateral mounting interface such that the second optical sight defines a second optical axis; positioning the second optical sight such that the second optical axis is laterally offset from the first optical axis; and arranging the first and second optical sights such that, when the firearm is shouldered, a shooter can view through the second optical sight with one eye while simultaneously viewing through the first optical sight with the other eye.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the disclosed subject matter. Of the drawings:

FIG. 1 is a perspective left-side view of an example firearm receiver having an upper region with an upper mounting interface and a side region with a lateral mounting interface;

FIG. 2 is a perspective right-side view of the receiver of FIG. 1;

FIG. 3 is a top view of the receiver of FIGS. 1-2 illustrating relative fore-aft placement of the upper mounting interface and one or more lateral mounting interfaces;

FIG. 4 is a schematic view identifying example side mounting regions on a receiver, including a forward left-side region, a forward right-side region, and a rearward left-side region (identified as Quadrants 1-3);

FIG. 5 is a view of a firearm sighting system in which a first optical sight is mounted to an upper mounting interface on the receiver and a second optical sight is mounted to a lateral mounting interface on a side of the receiver by a mounting bracket, such that the second optical sight is laterally offset from the first optical sight for binocular use;

FIG. 6 is another view of the firearm sighting system of FIG. 5 showing the second optical sight supported by the mounting bracket on the lateral mounting interface;

FIG. 7A is a view of an upper receiver for an AR-style firearm;

FIG. 7B is a view of the upper receiver of FIG. 7A including a laterally projecting horizontal mounting/anchor surface defining a lateral mounting interface for an accessory;

FIG. 7C is a view of the upper receiver with the horizontal mounting/anchor surface as assembled;

FIG. 8 is a view of an AR-style firearm configured with a first optical sight mounted to a top rail on the upper receiver and a second optical sight mounted laterally by a mounting bracket coupled to the lateral mounting interface, the second optical sight being laterally offset from the first optical sight for binocular use; and

FIGS. 9 and 10 are additional views of the firearm of FIG. 8 illustrating the laterally offset mounting of the second optical sight relative to the first optical sight.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Also, all conjunctions used are to be understood in the most inclusive sense possible. Thus, the word “or” should be understood as having the definition of a logical “or” rather than that of a logical “exclusive or” unless the context clearly necessitates otherwise. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

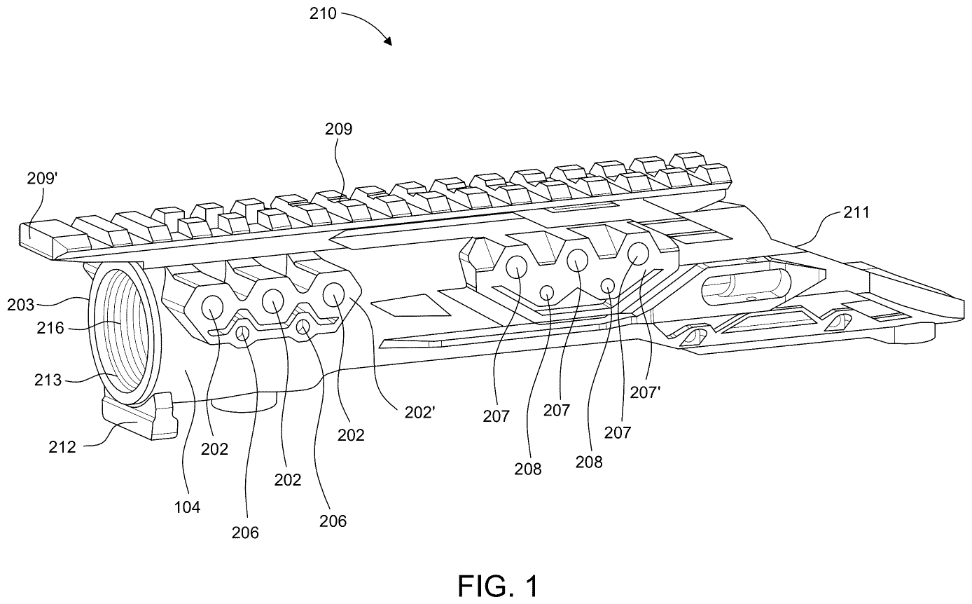

FIG. 1 is a perspective left side view of a firearm receiver 210.

The receiver 210 in some examples is made using traditional machining techniques. In the preferred embodiment, however, it is fabricated using metal 3D printing, or metal additive manufacturing. In general, when made additively, the receiver 210 is built layer by layer by fusing metal materials in different forms such as powder, wire, or sheets. Key types of additive manufacturing that can be used include Selective Laser Melting (SLM) and Direct Metal Laser Sintering (DMLS), which use high-powered lasers to fully melt or sinter metal powders in a powder bed to create precise, high-strength parts; Electron Beam Melting (EBM), similar to SLM but utilizing an electron beam in a vacuum chamber, ideal for materials like titanium; Binder Jetting, where a liquid binder selectively adheres metal powder particles that are later sintered in a furnace, suitable for complex geometries without requiring full density; Directed Energy Deposition (DED), which melts metal feedstock—either powder or wire—as it is deposited, allowing for the creation or repair of large-scale components; and Metal Extrusion processes like Bound Metal Deposition, where metal powder bound with a polymer is extruded and later sintered to form solid metal parts.

As is conventional, the receiver 210 includes barrel threads 213 for receiving a barrel and a recoil lug 212 on the underside of the receiver at or near the distal end portion 203, opposite the proximal end portion 211. This lug 212 is in the region of the barrel boss 104 and is also integral with the rest of the receiver 210 and fabricated as part of the metal 3D printing process used to fabricate the receiver 210.

The receiver has a reinforcing feature 218 in the region of and preferably below the ejection port 201.

A Picatinny rail 209 is located on the upper portion of the receiver 210. Preferably this is fabricated using metal 3D printing when entire receiver 210 is rendered. In the illustrated example, it extends along the entire top surface, extending above ejection port 201 and above barrel boss 104. Preferably, the rail 209 further projects as a cantilever beyond the distal end portion 203. This cantilevered portion of 209′ is usually greater than 5 millimeters (mm) long but often less than 30 mm long.

A left side distal mounting hole boss set 202 provides a left side distal side anchor point for accessories. Preferably this is fabricated using metal 3D printing when entire receiver 210 is rendered. The left side distal mounting hole boss set 202 is provided as a set of three bosses projecting laterally from the main body of the receiver 210, ending in a contiguous planar surface of 202′ to which an accessory can be securely clamped via bolts screwed into the boss set 202. The holes defined by these bosses are threaded, preferably ¼″ holes with a 28 thread pitch. In other examples, the threads are M5×0.8 mm thread, M4×0.7 mm thread or M6×1.0 mm. Preferably, the holes are threaded in a post processing step after the receiver body has been metal additively manufactured.

Preferably, the bosses 202 extend outward from the profile of the receiver by at least 1 millimeter or more. Preferably, they extend outward from the profile by several millimeters such as 3 or more, or 4 or more, or 5 or more millimeters.

In other examples, fewer than three bosses can be used such as one or two. In still other examples, more than three bosses can be used such as four or five.

The left side distal mounting hole boss set 202 is located along the length of the receiver near the distal end. The left side distal mounting hole boss set 202 is located vertically above the centerline of the barrel's axis 216 by more than 1 millimeter such as more than 2 mm or 3 mm or 4 mm and projects laterally outward orthogonally to the longitudinal axis or centerline of the receiver and horizontally.

Below the left side distal mounting hole boss set 202 are two left side distal indexing pin hole bosses 206 to receive indexing pins for holding a device that attaches to the receiver 210 with bolts engaging with the threaded holes of the left side distal mounting hole boss set 202. Preferably they are fabricated using metal 3D printing when the entire receiver 210 is rendered. Preferably the two left side distal indexing pin hole bosses 206 project outward from the centerline 216 ending at the contiguous planar surface of 202′ also encompassing the left side distal mounting hole boss set 202. This surface is often lapped after the receiver has been metal 3D printed in some examples to provide a smooth contiguous surface.

A left side proximal mounting hole boss set 207 is also provided as another set of three bosses projecting laterally from the main body of the receiver 210, at the left proximal side anchor point for accessories. Preferably this set is fabricated using metal 3D printing when the entire receiver 210 is rendered. The left side proximal mounting hole boss set 207 is located along the length of the receiver near the proximal end. The left side proximal mounting hole boss set 207 is also located above the centerline of the barrel's axis 216 by more than 1 millimeter such as more than 2 mm or 3 mm or 4 mm and projects laterally outward orthogonally to the longitudinal centerline of the receiver 210 and horizontally. Preferably, the boss set 207 extend outward from the profile of the receiver by at least 1 millimeter for more. Preferably, they extend outward from the profile by several millimeters such as 3 or more, or 4 or more, or 5 or more millimeters. The holes defined by these bosses are also threaded, preferably ¼″ holes with a 28 thread pitch or M5×0.8 mm thread, M4×0.7 mm thread or M6×1.0 mm.

Below the left side proximal mounting hole boss set 207 are two left side proximal indexing pin hole bosses 208 to receive indexing pins for holding a device that attaches to the receiver 210 with bolts engaging with the threaded holes of the left side proximal mounting hole boss set 207. Preferably they are fabricated using metal 3D printing when the entire receiver 210 is rendered.

Preferably the left side proximal mounting hole boss set 207 and the two left side proximal indexing pin hole bosses 208 project outward from the centerline 216 ending at a contiguous planar surface of 207′. This surface is often lapped after the receiver has been metal 3D printed in some examples to provide a smooth contiguous surface.

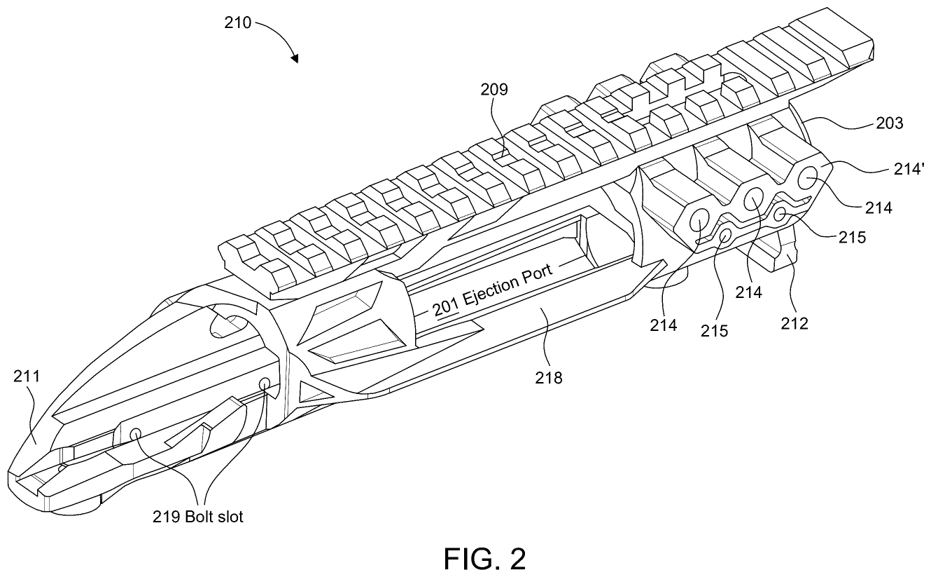

FIG. 2 is a perspective right side of the bolt receiver 210.

A right side distal mounting hole boss set 214 is provided as a set of three bosses projecting laterally from the main body of the receiver 210 providing a right side distal accessory anchor point. Preferably this is fabricated using metal 3D printing when the entire receiver 210 is rendered. Preferably, the boss set 214 extend outward from the profile of the receiver by at least 1 millimeter or more. Preferably, they extend outward from the profile by several millimeters such as 3 or more, or 4 or more, or 5 or more millimeters. The holes defined by these bosses are also threaded often as a post 3D printing machining process, preferably ¼″ holes with a 28 thread pitch or M5×0.8 mm thread, M4×0.7 mm thread or M6×1.0 mm.

The right side distal mounting hole boss set 214 is located along the length of the receiver near the distal end and forward of the ejection port 201. The right side distal mounting hole boss set 214 is located above the centerline of the barrel's axis by more than 1 millimeter such as more than 2 mm or 3 mm or 4 mm and projects laterally outward orthogonally to the longitudinal centerline of the receiver.

Below the right side distal mounting hole boss set 214 are two right side distal indexing pin hole bosses 215 to receive indexing pins for holding a device that attaches to the receiver 210 with bolts engaging with the threaded holes of the right side distal mounting hole boss set 214.

Preferably the right side distal mounting hole boss set 214 and the two right side distal indexing pin hole bosses 215 project outward from the centerline 216 also ending at a contiguous planar surface of 214′ that is often lapped smooth after the printing process.

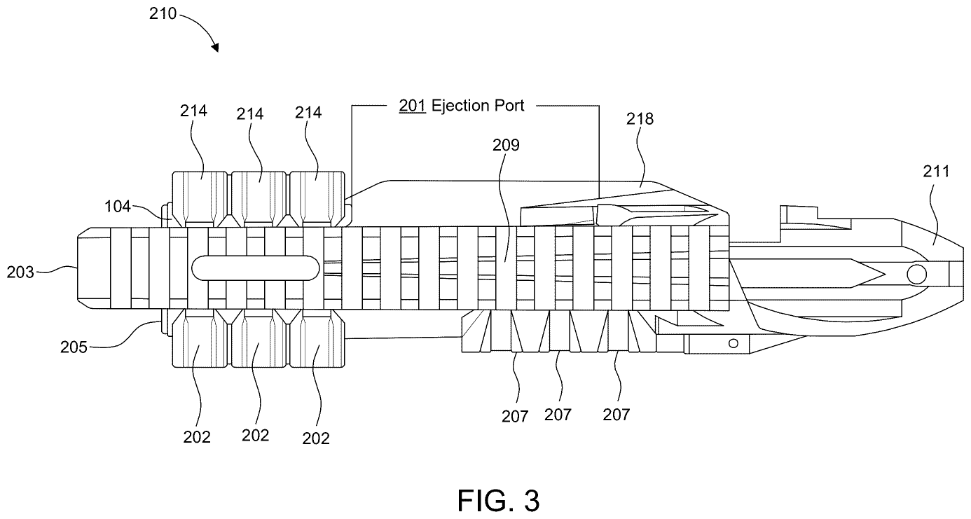

FIG. 3 is a top view of the bolt receiver.

As shown, the left side proximal mounting hole boss set 207 is located fore-aft on the receiver 210 at a point where the mid-point of the boss set 207 falls near the proximal beginning of the ejection port 201 on the opposite side of the receiver 210. Preferably, the mid-point of the boss set 207 is 3 mm or 4 mm or 5 mm or more, distal of the proximal beginning of the ejection port 201.

On the other hand, the left side distal mounting hole boss set 202 and the right side distal mounting hole boss set 214 are located forward of the ejection port 201 in the region of the barrel boss 104 and rearward of the barrel mating surface 205.

According to a method of use, in a typical case, the Picatinny rail 209 is used to secure a main optic such as a rifle scope or telescopic sight, and preferably a scope providing magnification such as 1.5× or 2× or more of magnification. On the other hand, the left side proximal mounting hole boss set 207 receives a reflex sight, i.e., a sight that has a reflective glass element to superimpose an illuminated reticle, such as a dot or other aiming point, onto the shooter's field of view or other non-magnifying optical sight.

According to another method of use, the right side distal mounting hole boss set 214 receives a reflex sight or other non-magnifying optical sight.

When a night sighting system is desired, it can be mounted to either or both of the left side proximal mounting hole boss set 207 and the left side distal mounting hole boss set 202, especially when the sighting system is physically large. Such a sighting system is often a traditional night vision device employing image intensification technology. A thermal imaging system that detects infrared radiation emitted as heat by objects is another option as is a digital night vision that combines low-light sensors with digital signal processing to display images on a screen. A fusion system is still another option, which integrates image intensification and thermal imaging technologies to overlay thermal data onto intensified images, providing a more comprehensive view that highlights both the detailed visual scene and the heat signatures within it.

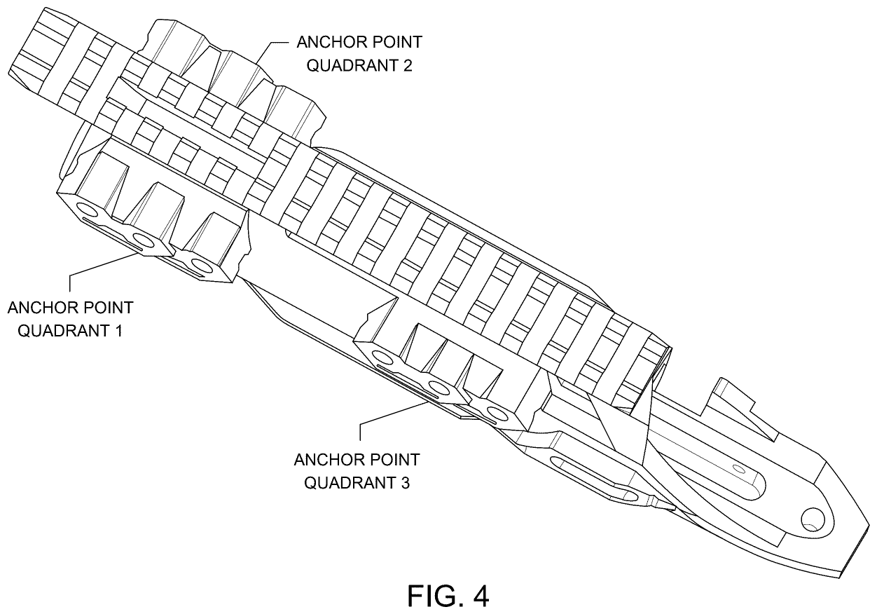

FIG. 4 shows the naming of the different anchor points, Quadrant 1, Quadrant 2, Quadrant 3.

Improving the bolt action, or other receivers with the ability to use both eyes for pointing/aiming is a significant improvement to current shoulder fired receivers. As all optics, emitters, range finders be they stadia metric or laser based are all aligned to the barreled action.

This improvement pertains to all forms of shoulder fired weapons and those in the category of modified definitions of rifles, carbines or other firearms as other than rifles or shoulder fired but retain the same key components such as a rifle receiver but a shorter barrel or utilizing a pistol caliber.

The novel idea in the following invention is the ability to anchor directly to the receiver/action, bypassing the need for a stock, chassis or other human interface to bear the flex, offset, material differentials and imperfect mounting options used for over 100 years. Mounting precision pointing/aiming or a Heads-Up display near to eye is invaluable during various hunting, tracking and shooting events. This enables the user to eliminate the use of hands to change magnification, add/remove technology, manipulate flip-type mounts and use both eyes simultaneously.

The following three items may be applied to all fashion of receivers in part or in whole. For various use cases one anchor point may apply, such as on a shotgun or carbine, whereas in others twp or three anchor points may apply such as in a bolt action rifle or Any Other Weapon (AOW), the BATF designation for a rifle used as a pistol.

1. Quadrants: For clarity, in the illustrated example, three different anchor points/areas/regions are depicted. These regions may use any type of rails, mounts, MLOK segments, etc. to affix via ¼″-28 tpi bolts, or other fasteners, pins or indexing hardware.
Quadrant 1: Left front of receiver.
Quadrant 2: Right front of receiver.
Quadrant 3: Left Rear of receiver.

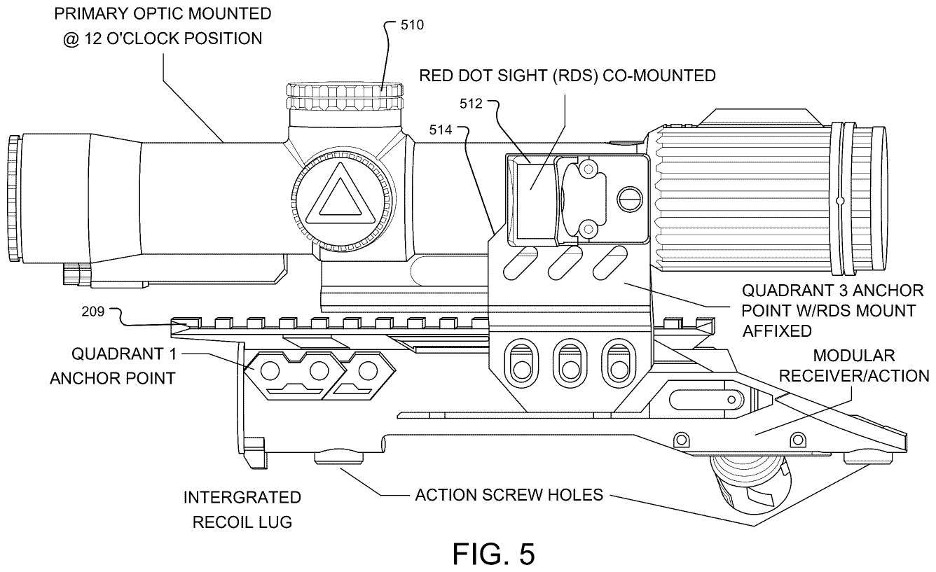

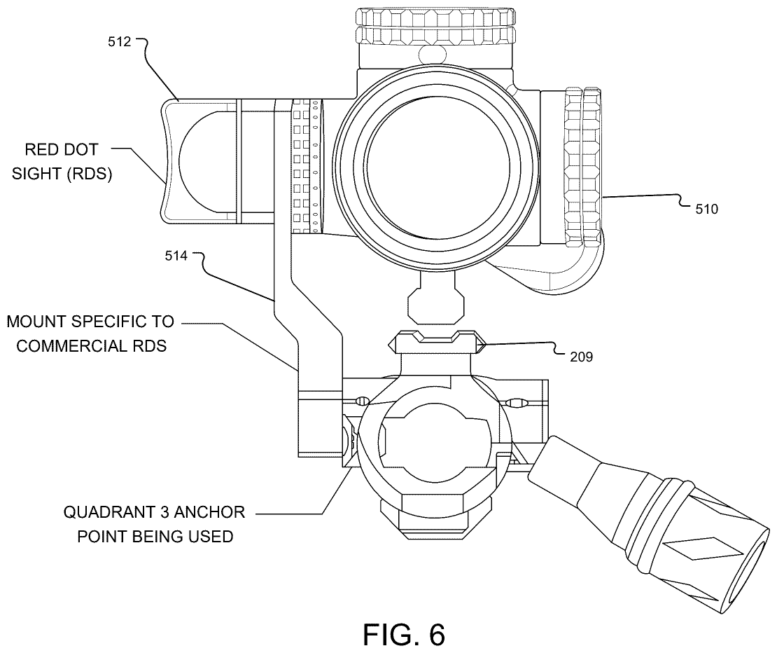

FIGS. 5 and 6 show an exemplary setup.

2. Rearward Primary Sight-RDS (red dot sight): FIGS. 5-6 illustrate one example of using the receiver's lateral anchor points to support more than one sighting/aiming device. In this example, a red-dot sight can be mounted on a rearward lateral mounting interface (e.g., at Quadrant 3) for binocular use—allowing a shooter to view through different sighting devices with different eyes—or, alternatively, for situational use with different technologies (e.g., reflex, night vision, thermal, or range-finding devices). In the illustrated example, a primary optic 510, a telescopic sight, commonly known as a scope, is an optical sighting device based on a refracting telescope. It is mounted on a firearm to provide an accurate point of aim by magnifying the target and placing a referencing pattern, called a reticle, in the shooter's field of view. In the illustrated example, it is mounted to the Picatinny rail 209.

3. Receiver Mounted RDS: The illustrated example shows how a robust mounting surface allows any second optic/emitter such as RDS 512 to be mounted by itself or with a primary optic mounted to the Picatinny rail 209 (see FIG. 2).

They depict simple use of Quadrant 3 Anchor point and associated hardware. These mounts and various technologies can include night vision, laser range finders, HUD's or any new technology brought to market. Here a bracket 514 connects a red-dot sight 512 to anchor point 3.

As shown in FIG. 6, it is possible for the shooter to simultaneously look through the red dot sight 512 with their left eye and the primary telescopic sight 510 with their right eye. Alternatively, the arrange could be reversed by moving the red dot to quadrant 2. Or greater eye relief distance could be achieved by moving the red dot to quadrant 1.

While FIGS. 5-6 illustrate an embodiment in which the first optical sight 510 is mounted to the upper mounting interface (e.g., rail 209) and the second optical sight 512 is mounted to a lateral mounting interface at Quadrant 3 via a bracket 514, in other embodiments the arrangement can be altered such that a first optical sight is mounted to a Quadrant 2 anchor point (i.e., a right-side forward lateral mounting interface, such as the right side distal mounting hole boss set 214 and associated planar surface 214′) instead of, or in addition to, being mounted to the rail 209. For example, an optic mount or bracket can be fastened to the Quadrant 2 anchor point and can support a first optical sight in an aligned or laterally offset position relative to the receiver centerline, with the rail 209 optionally supporting another optical sight or other accessory. In these alternative embodiments, the first optical sight mounted at Quadrant 2 can be a reflex sight, thermal sight, digital night vision sight, range-finding sight, or other aiming device, and the rail 209 can be used for a magnified optic or can remain unused depending on the intended configuration.

In further embodiments, the Quadrant 2 anchor point can be used to mount a third optical sight (or other auxiliary sighting device) while another optical sight is mounted to Quadrant 3 and/or while the first optical sight remains mounted to the upper mounting interface at rail 209. For instance, with a first optical sight 510 mounted to the rail 209 and a second optical sight 512 mounted at Quadrant 3 via bracket 514, an additional optical sight can be mounted at Quadrant 2 to provide a third aiming option that is laterally offset on the opposite side of the receiver. The availability of lateral mounting interfaces on multiple sides of the receiver also supports ergonomic configuration for different users, including left-handed shooters and/or shooters with different eye dominance. In particular, in some embodiments a laterally mounted sight (including a reflex sight) that is shown mounted at Quadrant 3 in FIGS. 5-6 may instead be mounted at Quadrant 2 so that, when the firearm is shouldered by a left-handed shooter, the laterally mounted sight is positioned for viewing by the shooter's selected eye while the other eye can simultaneously view through an optic mounted on the rail 209, thereby enabling the binocular aiming arrangements described herein.

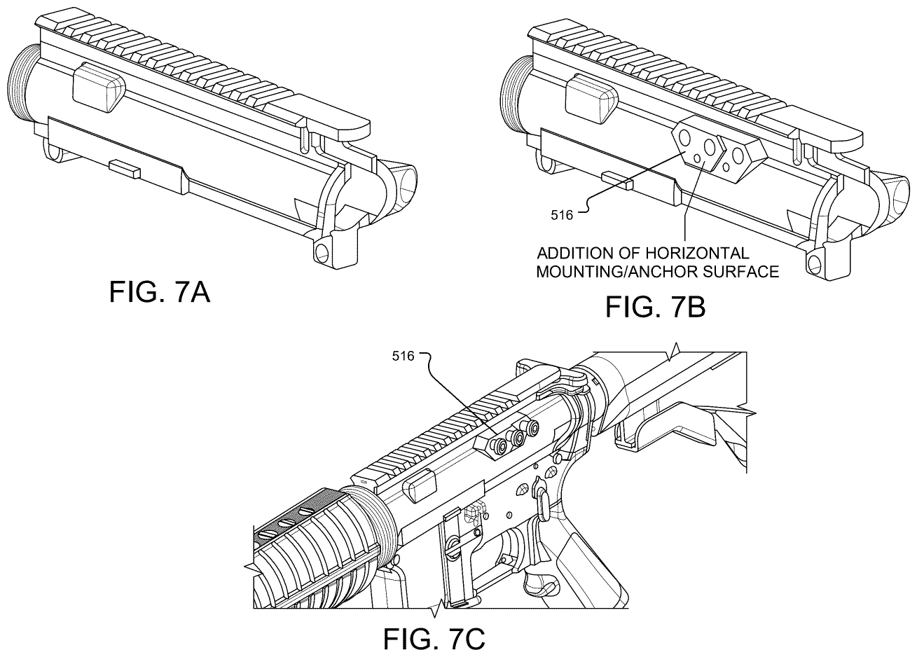

FIG. 7A shows an upper receiver for an AR-15 style weapon. FIG. 7B shows an upper receiver for an AR style weapon with the horizontal mounting/anchor surface for mounting extra optics, for example, according to the present invention. FIG. 7C shows the assembled receiver with the horizontal mounting/anchor surface. In the preferred embodiment, at least the upper receiver is manufactured using additive manufacturing, such as resin composite or metal 3D printing. In general, when made additively, the receiver 210 is built layer by layer by fusing metal materials in different forms such as powder, wire, or sheets. Key types of additive manufacturing that can be used include Selective Laser Melting (SLM) and Direct Metal Laser Sintering (DMLS), which use high-powered lasers to fully melt or sinter metal powders in a powder bed to create precise, high-strength parts; Electron Beam Melting (EBM), similar to SLM but utilizing an electron beam in a vacuum chamber, ideal for materials like titanium; Binder Jetting, where a liquid binder selectively adheres metal powder particles that are later sintered in a furnace, suitable for complex geometries without requiring full density; Directed Energy Deposition (DED), which melts metal feedstock—either powder or wire—as it is deposited, allowing for the creation or repair of large-scale components; and Metal Extrusion processes like Bound Metal Deposition, where metal powder bound with a polymer is extruded and later sintered to form solid metal parts.

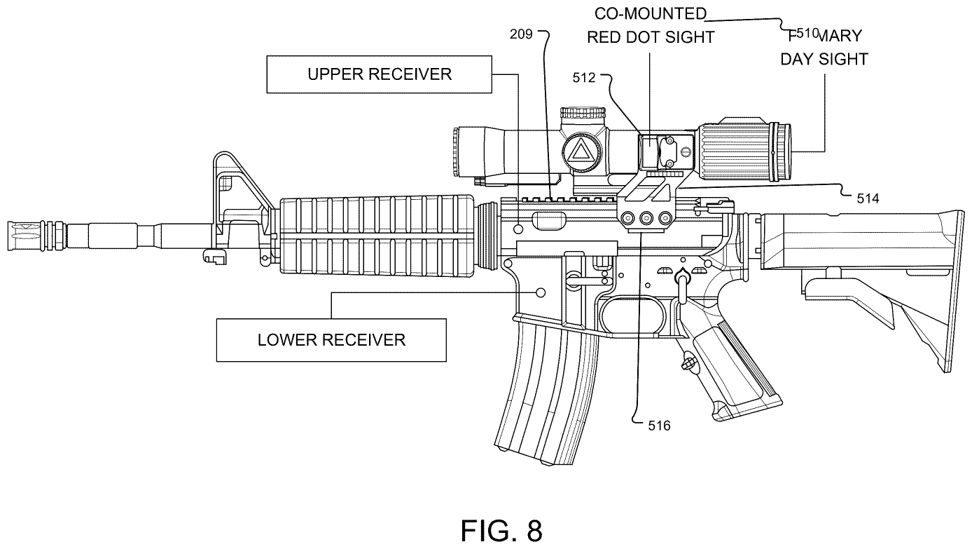

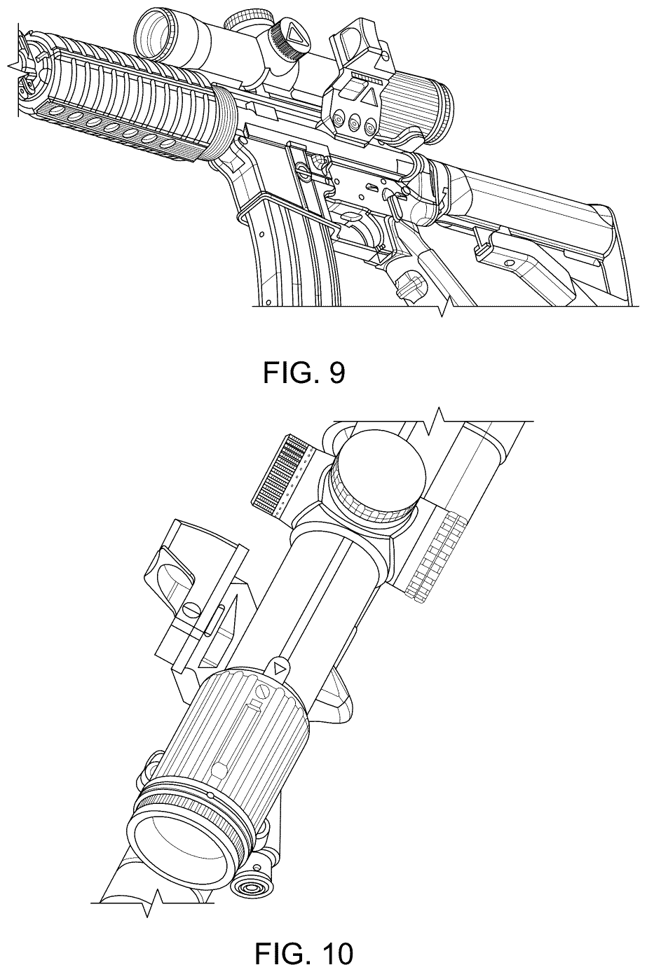

FIG. 8 shows the AR-15 style weapon with a primary telescopic sight 510 mounted on the top Picatinny rail 209 and a co-mounted red dot sight 512 held on a bracket 514 bolted to the horizontal mounting/anchor surface 516. FIGS. 9 and 10 show two more angles.

In the illustrated example, the red dot is mounted on the left, on the opposite side from the ejection port. The two optics are preferably co-aligned to the same point of point of aim. The bracket has a length selected so that the optical axes of both sights are parallel and horizontal. This allows the shooter to observe the target with their left eye through the red dot simultaneously to observing the target with their right eye through the primary sight.

Referring to FIGS. 5-6 and 8-10, the receiver can provide multiple distinct mounting interfaces for sighting devices. As used herein, an “upper mounting interface” refers to any rail, base, boss, threaded pattern, or other mounting feature located on an upper region of the receiver and configured to mount a first optical sight, such as a primary optic mounted on the top rail (e.g., rail 209 supporting optic 510). As used herein, a “lateral mounting interface” refers to any mounting surface, rail segment, boss set, aperture pattern, and/or fastener-receiving feature located on a side region of the receiver and configured to mount a second optical sight either directly or via an intermediate mount or bracket (e.g., bracket 514 supporting sight 512), including embodiments where the lateral mounting interface is defined by a laterally projecting planar surface and/or by a laterally projecting horizontal mounting/anchor surface (e.g., surface 516). The “optical axis” of an optical sight refers to the nominal line of sight of that optical sight when the sight is used for aiming. In the illustrated arrangements, the second optical sight defines a second optical axis that is laterally offset from the first optical axis (i.e., offset in a transverse left-right direction relative to the receiver and/or relative to the first optical axis), and in some embodiments the bracket and/or the lateral mounting interface positions the second optical sight so that the first and second optical axes are generally parallel and/or are aligned to a common point of aim at a selected distance. With the firearm in a normal shouldered firing position, the lateral offset arrangement enables a shooter to view through the second optical sight with one eye while simultaneously viewing through the first optical sight with the other eye.

While this invention has been particularly shown and described with references to preferred embodiments thereof, it will be understood by those skilled in the art that various changes in form and details may be made therein without departing from the scope of the invention encompassed by the appended claims.

What is claimed is:

1. A firearm sighting system, comprising:
a firearm receiver;
an upper mounting interface on an upper region of the receiver;
a lateral mounting interface on a side region of the receiver;
a first optical sight mounted to the upper mounting interface and defining a first optical axis;
a second optical sight mounted to the lateral mounting interface and defining a second optical axis;
wherein the second optical axis is laterally offset from the first optical axis; and
wherein the first optical sight and the second optical sight are arranged such that, when the firearm is shouldered, a shooter can view through the second optical sight with one eye while simultaneously viewing through the first optical sight with the other eye.

2. The firearm sighting system of claim 1, wherein the upper mounting interface comprises a Picatinny rail disposed on an upper portion of the firearm receiver.

3. The firearm sighting system of claim 1, wherein the lateral mounting interface comprises a laterally projecting mounting surface defining a plurality of threaded openings configured to receive threaded fasteners for securing the second optical sight or a mount supporting the second optical sight.

4. The firearm sighting system of claim 3, wherein the lateral mounting interface further comprises at least one indexing feature selected from an indexing pin hole, a dowel recess, and a locating boss, configured to resist rotation of the second optical sight or the mount supporting the second optical sight relative to the firearm receiver.

5. The firearm sighting system of claim 1, further comprising a mounting bracket secured to the lateral mounting interface, the mounting bracket having (i) a base portion coupled to the firearm receiver and (ii) an optic-support portion offset from the base portion, wherein the second optical sight is mounted to the optic-support portion.

6. The firearm sighting system of claim 1, wherein the first optical sight comprises a telescopic sight providing magnification, and wherein the second optical sight comprises a non-magnifying reflex sight.

7. The firearm sighting system of claim 1, wherein the lateral mounting interface is disposed on a side of the firearm receiver opposite an ejection port of the firearm receiver and is located above a centerline of a barrel axis by at least 2 millimeters.

8. A firearm sighting system, comprising:
a firearm receiver having an upper rail and/or a lateral mounting interface;
a magnified optic mounted to the upper rail and/or a lateral mounting interface;
a reflex sight mounted to a lateral portion of the receiver by a bracket attached to the receiver;
wherein the reflex sight is positioned at a lateral offset relative to the magnified optic and is configured to present an aiming indicia to a shooter's eye while the shooter simultaneously views through the magnified optic with the other eye.

9. A firearm, comprising:
an upper receiver having a top rail and/or a lateral mounting interface and a horizontal mounting surface laterally offset;
a first optical sight mounted to the top rail or lateral mounting interface; and
a second optical sight mounted to the horizontal mounting surface;
wherein the second optical sight is arranged for viewing by a first eye of a shooter while the first optical sight is arranged for viewing by a second eye of the shooter.

10. A method for configuring a firearm, comprising:
providing a firearm comprising a firearm receiver defining a longitudinal axis, the firearm receiver having (i) an upper mounting interface on an upper region of the receiver and (ii) a lateral mounting interface on a side region of the receiver;
mounting a first optical sight to the upper mounting interface such that the first optical sight defines a first optical axis;
mounting a second optical sight to the lateral mounting interface, directly or via an intermediate mounting bracket, such that the second optical sight defines a second optical axis;
positioning the second optical sight such that the second optical axis is laterally offset from the first optical axis; and
arranging the first optical sight and the second optical sight such that, when the firearm is shouldered, a shooter can view through the second optical sight with one eye while simultaneously viewing through the first optical sight with the other eye.

11. The method of claim 10, wherein providing the firearm receiver comprises providing the upper mounting interface as a Picatinny rail disposed on an upper region of the receiver.

12. The method of claim 10, wherein mounting the first optical sight comprises mounting a magnified telescopic sight as the first optical sight, and wherein mounting the second optical sight comprises mounting a non-magnifying reflex sight as the second optical sight.

13. The method of claim 10, wherein mounting the second optical sight to the lateral mounting interface comprises fastening a mounting bracket to the lateral mounting interface using threaded fasteners and securing the second optical sight to the mounting bracket.

14. The method of claim 13, further comprising indexing the mounting bracket to the firearm receiver using at least one indexing feature selected from an indexing pin, an indexing pin hole, and a locating boss to resist rotation of the mounting bracket relative to the firearm receiver.

15. The method of claim 10, wherein providing the firearm receiver comprises providing the lateral mounting interface as a laterally projecting horizontal mounting/anchor surface on an upper receiver of an AR-style firearm, and mounting the second optical sight comprises mounting the second optical sight to the horizontal mounting/anchor surface via the mounting bracket.
